(19) United States
(12) Patent Application Publication
(10) Pub. No.: US 2026/0036110 A1
(43) Pub. Date: Feb. 5, 2026

(54) Water Power Self-Circulating Generator

(71) Applicant: Fu-Hung Ho, Taichung City (CN)

(72) Inventor: Fu-Hung Ho, Taichung City (CN)

(21) Appl. No.: 18/793,822

(22) Filed: Aug. 4, 2024

(51) Int. Cl. F03B 13/06; F03B 7/00

(52) U.S. Cl. CPC F03B 13/06; F03B 7/00

(57) ABSTRACT

A water power self-circulating generator contains: a water tower, a water turbine, a magnetically-levitated wheel assembly, a generator head, a power storage cabinet, a storage tank, and a water pump. The water tower includes a water tube. The water turbine includes a body, an inlet, a discharge orifice, a turbine, a central shaft, a guide stator, and multiple spaced turbine blades. The magnetically-levitated wheel assembly includes a first rotatable disc and a second rotatable disc. The generator head is configured to produce direct currents (DC). The DC of the power storage cabinet is converted into alternating currents (AC) by an inverter. The storage tank is located below the discharge orifice. The water pump includes a draw tube and a supply tube.

### TECHNICAL FIELD

The present invention relates toa water self-circulating generator which is used for a regular replenishment of waters that naturally evaporates in operation, thus applying the waters of a water tower to supply power.

### BACKGROUND

Conventionally, the increasing depletion of petrochemical energy and the increasingly obvious impact of fossil fuels on the environment in recent years have led to the search for alternative energy sources, such as wind power, solar energy, ocean energy, hydraulic power, geothermal energy, and biomass energy. Thus, how to effectively utilize energy sources is the most pressing issues of this moment.

Wind power and hydropower can be defined as the use of windmills and waterwheels to convert the kinetic energy of wind and water into rotational motion to drive generators; although wind power and hydropower are clean and pollution-free energy sources that are safe and environmentally friendly. However, wind and water power are not inexhaustible natural resources. When there is no wind or water, the generator immediately loses its power generation capacity, which has existing problems and deficiencies that need to be overcome.

Due to the current unstable supply of water resources in various places, limited by insufficient water sources in rivers or irrigation ditches, small hydropower systems developed and designed by other industries cannot fully exert the expected effects.

The present invention has arisen to mitigate and/or obviate the afore-described disadvantages.

### SUMMARY

The primary aspect of the present invention is to provide a water power self-circulating generator which is capable of being installed on only one platform and applicable for a modular assembly design, so it is installed on both flat and mountainous areas. After the installation is completed, the first water source required for startup is manually fill the water storage tanks in the equipment and the water tower above with water, and then start operation.

Another aspect of the present invention is to provide a water power self-circulating generator which is capable of operating 24 hours a day and is not affected by the weather.

To obtain above-mentioned aspect, a water power self-circulating generator provided by the present invention contains: a water tower, a water turbine, a magnetically-levitated wheel assembly, a generator head, a power storage cabinet, a storage tank, and a water pump.

The water tower is mounted on a top of a tower support, the water tower includes a water tube fixed on a bottom thereof in a fixed slope to connect with the water turbine, and the water tower is connected with an external water source to supplement naturally evaporated waters when operating.

The water turbine includes a body, an inlet defined on a side of a top of the body and connected with the water tube of the water tower so that waters and airs are guided into the body from the inlet, a discharge orifice formed on a bottom of the body, a turbine mounted on a top of the body and corresponding to the discharge orifice, a central shaft connected on the turbine, a shunt disposed on the central shaft, a guide stator, and multiple spaced turbine blades. The guide stator has multiple grooves, and a respective one groove has a diameter-increased orifice defined on a top thereof and a diameter-decreased orifice formed on a bottom of the respective one groove, such that the multiple spaced turbine blades and the central shaft are actuated to rotate. The central shaft has a first pulley connected on a top thereof, and the first pulley has a first belt to drive the magnetically-levitated wheel assembly to rotate.

The magnetically-levitated wheel assembly includes a first rotatable disc and a second rotatable disc. The second rotatable disc has a holder fixed on a bottom thereof, the holder has a fixer connected on a bottom thereof. The first rotatable disc, the second rotatable disc, the holder and the fixer are rotatably connected with a rotary shaft, and the rotary shaft has a second pulley connected on a top thereof and configured to drive the first belt of the water turbine, and multiple frames separately surround the first rotatable disc and the second rotatable disc and are rotatably connected with multiple spaced rotation wheels. The holder has multiple first magnetic elements fixed on a bottom thereof, and the fixer has multiple second magnetic elements arranged on a top thereof and corresponding to the multiple first magnetic elements.

The generator head is configured to produce direct currents (DC), and the DC are saved in the power storage cabinet.

The DC of the power storage cabinet is converted into alternating currents (AC) by an inverter.

The storage tank is located below the discharge orifice of the water turbine and is configured to store the waters from the water turbine.

The water pump is disposed in the storage tank of the water turbine, and the water pump includes a draw tube and a supply tube. A diameter of the supply tube is smaller than a diameter of the water tube of the water tower, the water is supplied back to the water tower via the supply tube, and a power source supplied to the water pump comes from the power storage cabinet.

### BRIEF DESCRIPTION OF THE DRAWINGS

FIG. 1 is a schematic view showing the operation of a water power self-circulating generator according to a first embodiment of the present invention.

FIG. 2 is a schematic view showing the operation of a water power self-circulating generator according to a second embodiment of the present invention.

### DETAILED DESCRIPTION

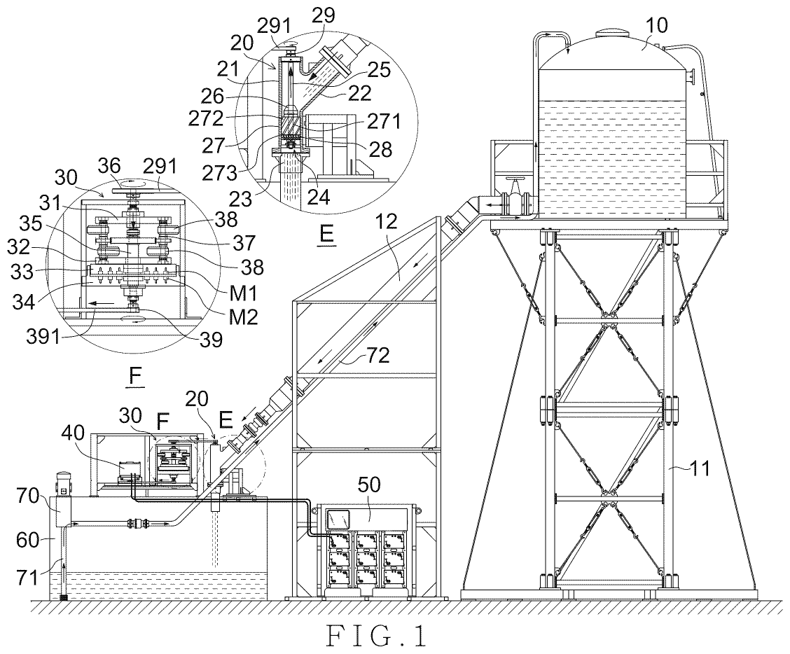

With reference to FIG. 1, a water power self-circulating generator according to a first embodiment of the present invention comprises: a water tower 10, a water turbine 20, a magnetically-levitated wheel assembly 30, a generator head 40, a power storage cabinet 50, a storage tank 60, and a water pump 70.

The water tower 10 is mounted on a top of a tower support 11 and is configured to provide a water pressure instead of waters, wherein the water tower 10 includes a water tube 12 fixed on a bottom thereof in a fixed slope (such as 45 degrees) to connect with the water turbine 20, and the water tower 10 is connected with an external water source to supplement naturally evaporated waters when operating.

The water turbine 20 includes a body 21, an inlet 22 defined on a side of a top of the body 21 so that the waters and airs are guided into the body 21 from the inlet 22, a discharge orifice 23 formed on a bottom of the body 21, a turbine 24 mounted on a top of the body 21 and corresponding to the discharge orifice 23, a central shaft 25 connected on the turbine 24, a shunt 26 disposed on the central shaft 25, a guide stator 27, and multiple spaced turbine blades 28, wherein the guide stator 27 has multiple grooves 271, and a respective one groove 271 has a diameter-increased orifice 272 defined on a top thereof and a diameter-decreased orifice 273 formed on a bottom of the respective one groove 271, such that a flowing speed of the waters is increased to actuate the multiple spaced turbine blades 28 and the central shaft 25 to rotate. The central shaft 25 has a first pulley 29 connected on a top thereof, and the first pulley 29 has a first belt 291, wherein the water turbine 20 is equal to a drive motor to drive the magnetically-levitated wheel assembly 30 to rotate.

The magnetically-levitated wheel assembly 30 includes a first rotatable disc 31 and a second rotatable disc 32, wherein the second rotatable disc 32 has a holder 33 fixed on a bottom thereof, the holder 33 has a fixer 34 connected on a bottom thereof, wherein the first rotatable disc 31, the second rotatable disc 32, the holder 33 and the fixer 34 are rotatably connected with a rotary shaft 35, and the rotary shaft 35 has a second pulley 36 connected on a top thereof and configured to drive the first belt 291 of the water turbine 20, and multiple frames 37 separately surround the first rotatable disc 31 and the second rotatable disc 32 and are rotatably connected with multiple spaced rotation wheels 38, wherein the holder 33 has multiple first magnetic elements M1 fixed on a bottom thereof, and the fixer 34 has multiple second magnetic elements M2 arranged on a top thereof and corresponding to the multiple first magnetic elements M2, wherein a polarity of the multiple first magnetic elements M1 is identical to a polarity of the multiple second magnetic elements M2, such that the multiple spaced rotation wheels 38 produce an upward magnetic levitation repulsion to reduce a loading and a friction force of the water turbine 20 to drive the magnetically-levitated wheel assembly 30. The rotary shaft 35 has a third pulley 39 on which a second belt 391 is fixed so as to amplify a torque to drive the generator head 40.

The generator head 40 is configured to produce direct currents of 48V and 5 Kw, wherein the 48V direct currents (DC) are saved in the power storage cabinet 50.

The DC of the power storage cabinet 50 is converted into alternating currents (AC) by an inverter or is supplied to an external loading directly.

The storage tank 60 is located below the discharge orifice 23 and is configured to store the waters from the water turbine 20.

The water pump 70 is disposed in the storage tank 60, and the water pump 70 includes a draw tube 71 and a supply tube 72, wherein a diameter of the supply tube 72 is smaller than a diameter of the water tube 12 of the water tower 10, a measured water flowing through the water turbine 20 is 800 L/min, so the water pump 70 is disposed in the storage tank 60 with 1 Kw to supply the waters in 800 L/min, a water delivery height reaches 10M, and the water is supplied back to the water tower 10 via the supply tube 72, thus achieving a complete self-circulating power generation in 24 hours. A power source supplied to the water pump 70 comes from the generator head 40 and the power storage cabinet 50.

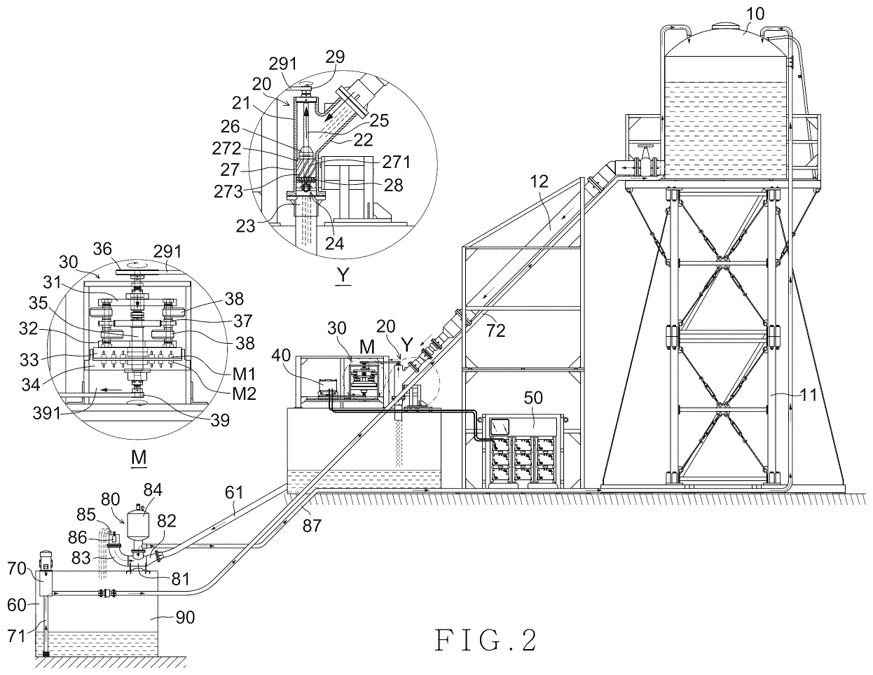

Referring to FIG. 2, in a second embodiment, a water power self-circulating generator comprises: a water tower 10, a water turbine 20, a magnetically-levitated wheel assembly 30, a generator head 40, a power storage cabinet 50, a first storage tank 60, a water distributor 80, and a second storage tank 90.

The water tower 10 is configured to provide a water pressure instead of waters, wherein the water tower 10 includes a water tube 12 fixed on a bottom thereof in a fixed slope (such as 45 degrees) to connect with the water turbine 20, and the water tower 10 is connected with an external water source to supplement naturally evaporated waters when operating.

The water turbine 20 includes a body 21, an inlet 22 defined on a side of a top of the body 21 so that the waters and airs are guided into the body 21 from the inlet 22, a discharge orifice 23 formed on a bottom of the body 21, a turbine 24 mounted on a top of the body 21 and corresponding to the discharge orifice 23, a central shaft 25 connected on the turbine 24, a shunt 26 disposed on the central shaft 25, a guide stator 27, and multiple spaced turbine blades 28, wherein the guide stator 27 has multiple grooves 271, and a respective one groove 271 has a diameter-increased orifice 272 defined on a top thereof and a diameter-decreased orifice 273 formed on a bottom of the respective one groove 271, such that a flowing speed of the waters is increased to actuate the multiple spaced turbine blades 28 and the central shaft 25 to rotate. The central shaft 25 has a first pulley 29 connected on a top thereof, and the first pulley 29 has a first belt 291, wherein the water turbine 20 is equal to a drive motor to drive the magnetically-levitated wheel assembly 30 to operate.

The magnetically-levitated wheel assembly 30 includes a first rotatable disc 31 and a second rotatable disc 32, wherein the second rotatable disc 32 has a holder 33 fixed on a bottom thereof, the holder 33 has a fixer 34 connected on a bottom thereof, wherein the first rotatable disc 31, the second rotatable disc 32, the holder 33 and the fixer 34 are rotatably connected with a rotary shaft 35, and the rotary shaft 35 has a second pulley 36 connected on a top thereof and configured to drive the first belt 291 of the water turbine 20, multiple frames 37 separately surrounds the first rotatable disc 31 and the second rotatable disc 32 and are rotatably connected with multiple spaced rotation wheels 38, wherein the holder 33 has, multiple first magnetic elements M1 fixed on a bottom thereof, and the fixer 34 has multiple second magnetic elements M2 arranged on a top thereof and corresponding to the multiple first magnetic elements M2, wherein a polarity of the multiple first magnetic elements M1 is identical to a polarity of the multiple second magnetic elements M2, such that the multiple spaced rotation wheels 38 produce an upward magnetic levitation repulsion to reduce a loading and a friction force of the water turbine 20 to drive the magnetically-levitated wheel assembly 30. The rotary shaft 35 has a third pulley 39 on which a second belt 391 is fixed so as to amplify a torque to drive the generator head 40.

The generator head 40 is configured to produce direct currents of 48V and 5 Kw, wherein the 48V direct currents (DC) are saved in the power storage cabinet 50.

The DC of the power storage cabinet 50 is converted into alternating currents (AC) by an inverter or is supplied to an external load directly.

The first storage tank 60 is located below the discharge orifice 23 of the water turbine 20 and is configured to store the waters from the water turbine 20, wherein the first storage tank 60 includes an inflow tube 61 connected on a bottom thereof and corresponding to a side of the body 80.

The water pump 70 is disposed in the first storage tank 60, and the water pump 70 includes a draw tube 71 and a supply tube 72, wherein a diameter of the supply tube 72 is smaller than a diameter of the water tube 12 of the water tower 10, a measured water flowing through the water turbine 20 is 800 L/min, so the water pump 70 is disposed in the first storage tank 60 with 1 Kw to supply the waters in 800 L/min, and a water delivery height reaches 10M, thus achieving complete self-circulating power generation in 24 hours. A power source supplied to the water pump 70 comes from the generator head 40 and the power storage cabinet 50.

The water distributor 80 includes a body 81, an inlet tube 82 connected on the side of the body 81 and corresponding to the inflow tube 61 of the first storage tank 60, a curved tube 83 connected on the other side of the body 81 and corresponding to the inlet tube 82, a pressurized cylinder 84 fixed on a top of the body 81, a cap 85 mounted on a top of the curved tube 83, and a counterweight element 86 disposed on a center of the cap 85, such that when the waters of the pressurized cylinder 84 overflow and push the cap 85 to open, the waters flow to the second storage tank 90 via the curved tube 83. A return tube 87 is connected on a bottom of the pressurized cylinder 84, wherein a diameter of the return tube 87 is smaller than a diameter of the water tube 12 of the water tower 10. When the cap 85 is opened and closed repeatedly, the pressurized cylinder 84 is pressurized so that the waters are guided back to the water tower 10 via the return tube 87. The water distributor 80 is not connected with an external power source to increase a power storage capacity of the generator head 40, the waters discharged by the water turbine 20 flow to the water distributor 80 via the inflow tube 61 of the first storage tank 60, and the water distributor 80 delivers 40% waters back to the water tower 10, so the water pump 70 saves 15% power consumption.

The second storage tank 90 is located below the curved tube 83 of the water distributor 80 and is configured to save the waters from the water distributor 80.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A water power self-circulating generator comprising: a water tower, a water turbine, a magnetically-levitated wheel assembly, a generator head, a power storage cabinet, a storage tank, and a water pump;
wherein the water tower is mounted on a top of a tower support, the water tower includes a water tube fixed on a bottom thereof in a fixed slope to connect with the water turbine, and the water tower is connected with an external water source to supplement naturally evaporated waters when operating;
wherein the water turbine includes a body, an inlet defined on a side of a top of the body and connected with the water tube of the water tower so that waters and airs are guided into the body from the inlet, a discharge orifice formed on a bottom of the body, a turbine mounted on a top of the body and corresponding to the discharge orifice, a central shaft connected on the turbine, a shunt disposed on the central shaft, a guide stator, and multiple spaced turbine blades, wherein the guide stator has multiple grooves, and a respective one groove has a diameter-increased orifice defined on a top thereof and a diameter-decreased orifice formed on a bottom of the respective one groove, such that the multiple spaced turbine blades and the central shaft are actuated to rotate, wherein the central shaft has a first pulley connected on a top thereof, and the first pulley has a first belt to drive the magnetically-levitated wheel assembly to rotate;
wherein the magnetically-levitated wheel assembly includes a first rotatable disc and a second rotatable disc, wherein the second rotatable disc has a holder fixed on a bottom thereof, the holder has a fixer connected on a bottom thereof, wherein the first rotatable disc, the second rotatable disc, the holder and the fixer are rotatably connected with a rotary shaft, and the rotary shaft has a second pulley connected on a top thereof and configured to drive the first belt of the water turbine, and multiple frames separately surround the first rotatable disc and the second rotatable disc and are rotatably connected with multiple spaced rotation wheels, wherein the holder has multiple first magnetic elements fixed on a bottom thereof, and the fixer has multiple second magnetic elements arranged on a top thereof and corresponding to the multiple first magnetic elements, wherein a polarity of the multiple first magnetic elements is identical to a polarity of the multiple second magnetic elements, such that the multiple spaced rotation wheels produce an upward magnetic levitation repulsion to reduce a loading and a friction force of the water turbine to drive the magnetically-levitated wheel assembly, and the rotary shaft has a third pulley on which a second belt is fixed to drive the generator head;
wherein the generator head is configured to produce direct currents (DC), and the DC are saved in the power storage cabinet;
wherein the DC of the power storage cabinet is converted into alternating currents (AC) by an inverter;
wherein the storage tank is located below the discharge orifice of the water turbine and is configured to store the waters from the water turbine;
and the water pump is disposed in the storage tank of the water turbine, and the water pump includes a draw tube and a supply tube, wherein a diameter of the supply tube is smaller than a diameter of the water tube of the water tower, the water is supplied back to the water tower via the supply tube, and a power source supplied to the water pump comes from the power storage cabinet.

2. The water power self-circulating generator as claimed in claim 1, wherein the water tube of the water tower is connected with the inlet of the water turbine in 45 degrees.

3. The water power self-circulating generator as claimed in claim 1, wherein the DC of the power storage cabinet is supplied to an external loading directly.

4. A water power self-circulating generator comprising: a water tower, a water turbine, a magnetically-levitated wheel assembly, a generator head, a power storage cabinet, a first storage tank, a water distributor, and a second storage tank;
wherein the water tower is mounted on a top of a tower support, the water tower includes a water tube fixed on a bottom thereof in a fixed slope to connect with the water turbine, and the water tower is connected with an external water source to supplement naturally evaporated waters when operating;
wherein the water turbine includes a body, an inlet defined on a side of a top of the body and connected with the water tube of the water tower so that waters and airs are guided into the body from the inlet, a discharge orifice formed on a bottom of the body, a turbine mounted on a top of the body and corresponding to the discharge orifice, a central shaft connected on the turbine, a shunt disposed on the central shaft, a guide stator, and multiple spaced turbine blades, wherein the guide stator has multiple grooves, and a respective one groove has a diameter-increased orifice defined on a top thereof and a diameter-decreased orifice formed on a bottom of the respective one groove, such that the multiple spaced turbine blades and the central shaft are actuated to rotate, wherein the central shaft has a first pulley connected on a top thereof, and the first pulley has a first belt to drive the magnetically-levitated wheel assembly to rotate;
wherein the magnetically-levitated wheel assembly includes a first rotatable disc and a second rotatable disc, wherein the second rotatable disc has a holder fixed on a bottom thereof, the holder has a fixer connected on a bottom thereof, wherein the first rotatable disc, the second rotatable disc, the holder and the fixer are rotatably connected with a rotary shaft, and the rotary shaft has a second pulley connected on a top thereof and configured to drive the first belt of the water turbine, and multiple frames separately surround the first rotatable disc and the second rotatable disc and are rotatably connected with multiple spaced rotation wheels, wherein the holder has multiple first magnetic elements fixed on a bottom thereof, and the fixer has multiple second magnetic elements arranged on a top thereof and corresponding to the multiple first magnetic elements, wherein a polarity of the multiple first magnetic elements is identical to a polarity of the multiple second magnetic elements, such that the multiple spaced rotation wheels produce an upward magnetic levitation repulsion to reduce a loading and a friction force of the water turbine to drive the magnetically-levitated wheel assembly, and the rotary shaft has a third pulley on which a second belt is fixed to drive the generator head;
wherein the generator head is configured to produce direct currents (DC), and the DC are saved in the power storage cabinet;
wherein the DC of the power storage cabinet is converted into alternating currents (AC) by an inverter;
wherein the first storage tank is located below the discharge orifice of the water turbine and is configured to store the waters from the water turbine, and the first storage tank includes an inflow tube connected on a bottom thereof and corresponding to a side of the body;
wherein the water pump is disposed in the first storage tank of the water turbine, and the water pump includes a draw tube and a supply tube, wherein a diameter of the supply tube is smaller than a diameter of the water tube of the water tower, the water is supplied back to the water tower via the supply tube, and a power source supplied to the water pump comes from the power storage cabinet;
wherein the water distributor includes a body, an inlet tube connected on the side of the body and corresponding to the inflow tube of the first storage tank, a curved tube connected on the other side of the body and corresponding to the inlet tube, a pressurized cylinder fixed on a top of the body, a cap mounted on a top of the curved tube, and a counterweight element disposed on a center of the cap, such that when the waters of the pressurized cylinder overflow and push the cap to open, the waters flow to the second storage tank via the curved tube, wherein a return tube is connected on a bottom of the pressurized cylinder, a diameter of the return tube is smaller than a diameter of the water tube of the water tower, when the cap is opened and closed repeatedly, the pressurized cylinder is pressurized so that the waters are guided back to the water tower via the return tube; and
wherein the second storage tank is located below the curved tube of the water distributor and is configured to save the waters from the water distributor.

5. The water power self-circulating generator as claimed in claim 4, wherein the water tube of the water tower is connected with the inlet of the water turbine in 45 degrees.

6. The water power self-circulating generator as claimed in claim 4, wherein the DC of the power storage cabinet is supplied to an external loading directly.
